(19) United States
(12) Patent Application Publication
(10) Pub. No.: US 2009/0133560 A1
(43) Pub. Date: May 28, 2009

(54) Paper punch

(76) Inventors: Peter Chen, West Windsor, NJ (US); Jungkun Lee, Edison, NJ (US); Kevin Hui-Lien Lee, East Brunswick, NJ (US)

Correspondence Address: Daniel Kirshner, Attorney at Law, 199 Route 18 South, East Brunswick, NJ, 08816, US

(21) Appl. No.: 11/906,937

(22) Filed: Oct. 4, 2007

Related U.S. Application Data
(63) Continuation of application No. 11/152,436, filed on Jun. 14, 2005, now abandoned.

(51) Int. Cl. B26D 5/08

(52) U.S. Cl. 83/588

(57) ABSTRACT

A desk-top paper punch includes a drawer for removable insertion into the base of the paper punch, the drawer serving as a collection receptacle for paper punches to be discarded. Once the drawer is near its capacity, the drawer is pulled out of the base for emptying. Means for viewing the contents of the drawer is provided. In one implementation, the view means is a transparent window which allows the viewer to know when the drawer in nearing its capacity for paper chips. In a second embodiment, the viewing means is at least one viewing aperture that perforates the top surface of the base of the paper punch that allows the user to view the drawer's contents.

### CROSS REFERENCE TO RELATED APPLICATION

This application is a continuation of the previously filed application bearing application Ser. No. 11/152,436 and claims priority and the filing date thereof.

### FIELD OF THE INVENTION

The present invention is a desk-top paper punch for punching holes in paper. More specifically, the present invention paper punch includes a collection drawer for collecting paper punches and means for viewing the contents of the collection drawer.

### BACKGROUND OF THE INVENTION

Paper punches are well known in the prior art and are used to punch holes in paper so that the paper can be bound together. Paper punches are available in a variety of configurations ranging from hand-held one-hole punches, to desk-top two-hole punches for binding papers in a file folder to three-hole punches for binding papers in a loose-leaf type binder. All of these share common elements.

Typical prior art desk-top paper punches include a base, punch rods, and a pivoting handle. The base has a top surface upon which a stack of papers is positioned. The one or more punch rods are utilized for punching holes in paper, said punch rods travel into punch apertures on the base. A paper slot for inserting paper is defined by the space between the base and the punch rods. The handle is used for pivotally activating the one or more punch rods thereby pushing the punch rods through the stack of paper and into the punch apertures thereby punching holes in the paper. In addition, typical prior art paper punches include a collection receptacle for collecting the discarded paper punches. Usually, this collection receptacle takes the form of a plastic or flexible cover that is form fitted onto the bottom of the base and is removed for emptying by deforming the flexible cover.

One disadvantage of prior art paper punches is that the process of emptying the paper punch receptacle is cumbersome. The paper punch must be held in one hand of the user, and the flexible cover deformed and removed using the other hand. This is more problematic in the case of larger, heavier duty desk-top paper punches. In addition, when emptying prior art paper punches with deformable paper receptacle covers, discarded paper punches often fly willy-nilly and end up on the floor. Furthermore, prior art paper punches do not allow the user to view the contents of the paper punch receptacle. As a consequence, the user may empty the receptacle more often than necessary. Even worse, the user may wait too long to empty the paper receptacle thereby causing the punch rod to come into contact with the paper punches, thereby causing dulling of the punch rods.

The above-noted deficiencies are addressed by the present invention desk-top paper punch which includes a drawer for removably retaining the paper punches (chips). Moreover, the present invention paper punch includes means for viewing the contents of the drawer so that the user will know when it is time for emptying.

Such are the objectives of the present invention paper punch. Other objectives, advantages and novel features, and further scope of applicability of the present invention will be set forth in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### SUMMARY OF THE INVENTION

The present invention is a desk-top paper punch which is disclosed in several implementations. Each of the implementations incorporate the same novel features. The paper punch includes a drawer for removable insertion into the base of the paper punch, the drawer serving as a collection receptacle for paper punches (a/k/a chips) to be discarded. Once the drawer is near its chip capacity, the drawer is pulled out of the base for emptying. Means for viewing the contents of the drawer is provided. In one implementation, the view means is a transparent window which allows the viewer to know when the drawer in nearing its capacity for paper chips. In a second embodiment, the viewing means is at least one viewing aperture that perforate the top surface of the base of the paper punch that allows the user to view the drawer's contents. In either case, the user will know that it is time to empty the drawer which can easily be moved from the base for emptying and subsequently repositioned into the base.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a right side perspective view of the deluxe two-hole implementation of the present invention paper punch as viewed from above.

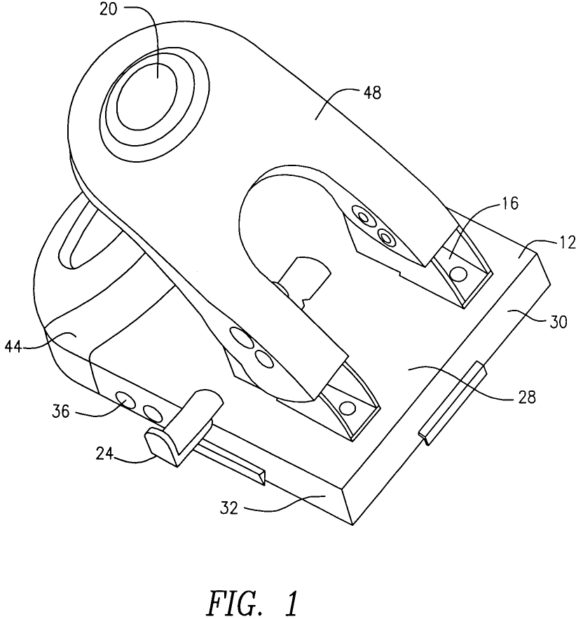

FIG. 2 is a left side perspective view of the deluxe two-hole implementation of the present invention paper punch as viewed from above.

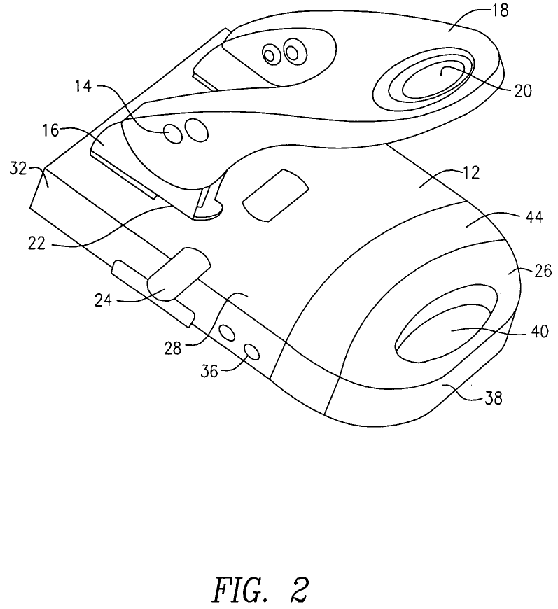

FIG. 3 is an exploded left side perspective view of the deluxe two-hole implementation of the present invention paper punch as viewed from above.

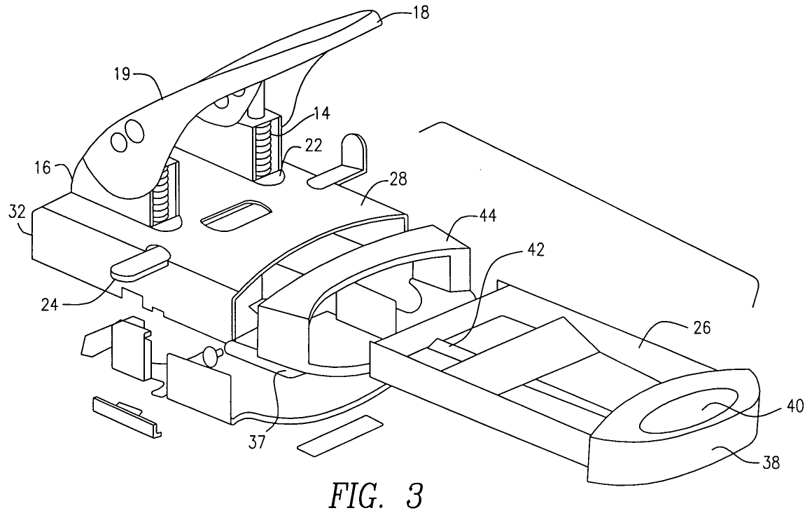

FIG. 4 is an exploded right side perspective view of the deluxe two-hole implementation of the present invention paper punch as viewed from below.

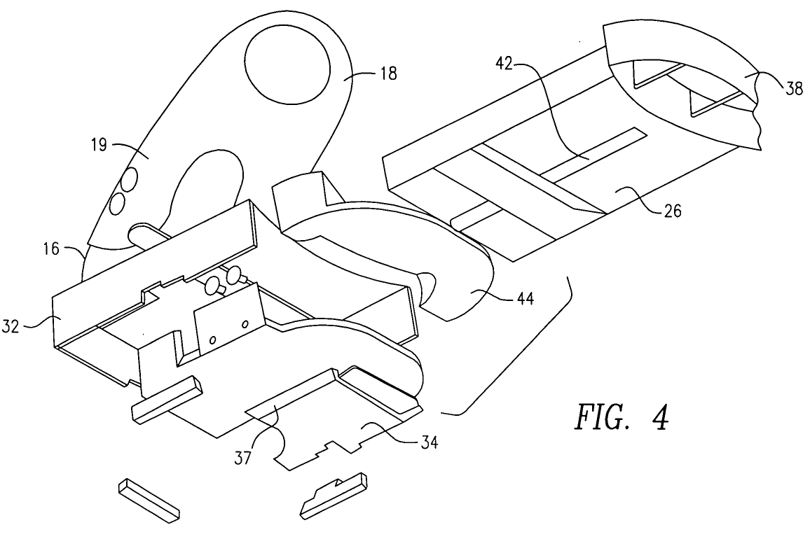

FIG. 5 is a perspective front view of the deluxe three-hole implementation of the present invention paper punch.

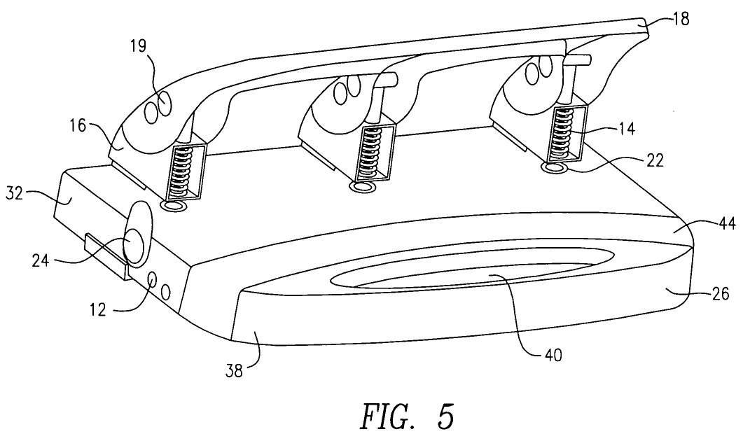

FIG. 6 is a perspective rear view of the deluxe three-hole implementation of the present invention paper punch.

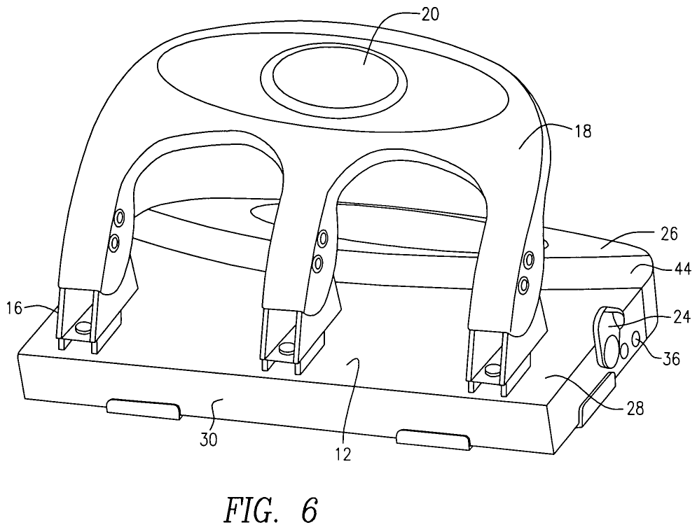

FIG. 7 is an exploded perspective view of the deluxe three-hole implementation of the present invention paper punch.

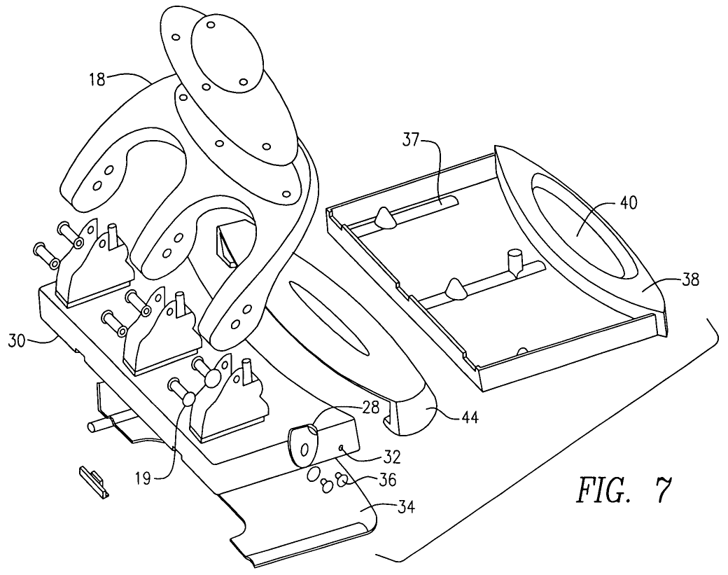

FIG. 8 is a front perspective view of the economy version of the present invention paper punch.

### DETAILED DESCRIPTION OF THE INVENTION

Referring to the drawings, the present invention is a desk-top paper punch. Four similar implementations of the present invention are contemplated—a two-hole punch version and a three-hole punch version, both presented in economy and deluxe versions. (The difference between the economy and deluxe versions is the size of the units and their respective components and therefore the paper stack capacity. In addition, the heavy-duty models include a padded handle for comfort of use. ) The paper punch of the present invention includes prior art features such as a base 12, spring-loaded punch rods 14 which are enclosed in a punch-rod housing 16, and a handle 18 which is riveted to the punch rod housing using rivets 19. In the deluxe models, the handle includes a pad 20 to cushion the user's hand. Paper is positioned into the slot 22 defined by the punch rod housing 16 and the base 12. The positioning of the paper on the paper punch is guided through use of the paper guide 24. The position of the paper guide is adjustable in the two-hole model so that the user can punch either legal or letter size paper. The paper guide in the three-hole model is fixed in position as people generally do not punch three holes in legal size paper. The operator applies downward pressure on the handle 18, thereby forcing the punch rods 14 through the stack of paper wherein holes are punched therethrough. Discarded paper punches or “chips” are collected in a collection housing, which typically in the prior art is a molded flexible bottom cover that is sized and configured to fit snugly onto the base of the punch. In typical prior art units, the collection housing is emptied by manually removing the deforming and manually removing and empting the bottom cover.

In the present invention, the base 12 is configured to accommodate a drawer 26, said drawer utilized to collect paper punches (chips). As such, the base has a top surface 28, upon which top surface is placed the stack of paper and through which punch holes are formed. Furthermore, a best shown in the exploded view of figure, the base includes a back wall 30 and two side walls 32. No front wall is presented, as the drawer will be inserted through the front of the base. In the embodiments shown herein, the base includes a bottom wall 34 as well, said bottom wall manufactured as a separate piece that is attached to the base by rivets 36. As shown, the bottom wall extends further forward than the top surface of the base so that the bottom wall will serve as a support for the drawer. Extending upward from the bottom wall and into the drawer cavity is at least one (one in the two-hole version and three in the three-hole versions) semi-circular guide ridge 37 which functions as drawer guide.

The drawer unit 26 is employed as a collection receptacle to collect the discarded paper chips. The drawer is typically molded from plastic and slideably inserts into the base 12 so that it can be inserted and removed easily for emptying paper punches. More specifically, the drawer is inserted into the front of the base and nestles atop the bottom wall and snugly between the side walls of the base. At the front of the drawer is positioned a finger-pull section 38 of the drawer. The finger-pull section is substantially elliptical in shape, and its top surface is slightly elevated from the side walls of the drawer. Included on the top surface of the finger-pull section of the drawer is an elliptical finger depression 40 for finger insertion. As an alternative to the finger depression, a handle for pulling the drawer out may be positioned on the front of the drawer.

As the punches that include an upward extending guide ridge or ridges on the bottom wall, a corresponding number of semi-circular guide slots 42 are formed into the bottom of the drawer. These semi-circular slots are sized, configured and positioned to match with the drawer guide ridges on the base. In other words, the semi-circular guide slots 42 extend upward into the drawer and receive the semi-circular ridges that extend upward from the bottom of the base. Naturally, there must be an equal number of slots and ridges on the unit (three in the three-hole punch and one in the two-hole punch.) In conjunction, the slots on the bottom and ridges on the drawer coordinate to guide the drawer in and out of the base.

To better view the contents of the punch collection drawer, the present invention paper punch includes means to view the contents of the drawer. In the case of the deluxe model paper punches, the viewing means is a transparent window 44 molded from plastic. Although a plastic window is disclosed, any transparent material can be utilized. The top surface of the transparent window is positioned between the finger pull section of the drawer and the top surface of the base. As such, the top surface of the base, the top surface of the window and the top surface of the finger pull section all reside on the same horizontal plane. Furthermore, the transparent window includes curvilinear side walls that extend downward from its top surface, the side walls located between the side wall of the base and the finger-pull section of the drawer. Moreover, the window has a curvilinear front face which mates with the curved surface of the back of the finger pull section of the drawer.

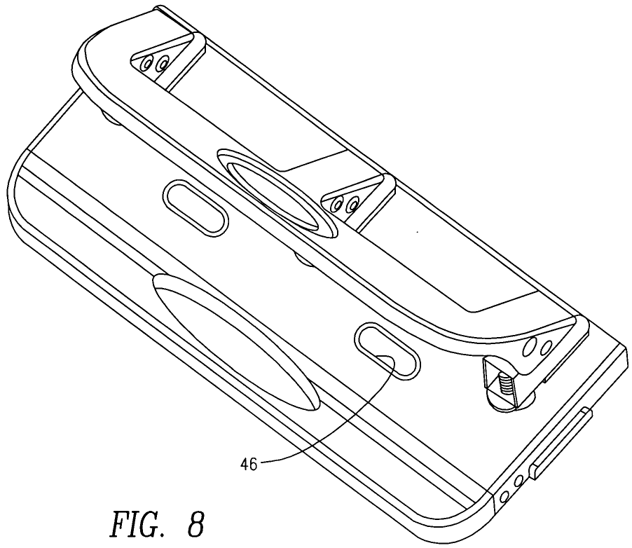

As seen in FIG. 8, in the economy implementation of the invention, the means for viewing the contents of the drawer is one or more viewing apertures 46. These viewing apertures perforate the top surface of the base and allow the user to view the contents of the drawer.

To utilize this invention, a user inserts a stack of papers into the slot between the punch rods and the base and then applies downward force onto the handle. This forces the punch rods through the paper causing holes to be punched therein and the punch rods continue through punch-rod apertures on the base. The discarded punches or paper chips are pushed through and into the collection drawer. The user monitors the amount of discarded punches that accumulates in the drawer. Now, when the drawer is full of punches to near its capacity, the user pulls out the drawer from the base and empties its contents. As such, the collection of paper punches is discarded in a neat and tidy fashion without them being strewn about. Furthermore, because. the contents of the drawer is monitored by way of the viewing means, the danger of excessive contact between the punch rods and paper chips (which causes dulling of the punch rods) is reduced.

The foregoing is considered as illustrative only of the principles and preferred embodiment of the invention. Furthermore, since numerous changes and modifications will readily occur to one skilled in the art, it is not desired to limit the invention to the exact construction, operation and embodiment shown and described, and accordingly all suitable modifications and equivalents may be resorted to, falling within the scope of the invention.

1. A desk-top paper punch for punching holes in paper comprising:
a. a base, said base having a top surface for placement of paper;
b. a pull out-drawer having a top surface for collecting paper punches that inserts into said base said drawer removable for emptying, wherein said drawer further includes a finger-pull section formed as a depression into said top surface of said drawer; and
c. a window for viewing the contents of said drawer whereby the user will be able to see when the drawer needs emptying, said window being positioned on a horizontal plane substantially parallel to said top surface of said base, said window including viewing means formed from transparent material.

2. (canceled)

3. (canceled)

4. (canceled)

5. (canceled)

6. (canceled)

7. (canceled)
